(19) United States
(12) Patent Application Publication
(10) Pub. No.: US 2011/0011944 A1
(43) Pub. Date: Jan. 20, 2011

(54) SPRAY TANNING DELIVERY DEVICE

(75) Inventor: CANDICE BOYNE, LOS ANGELES, CA (US)

Correspondence Address: SHIMOKAJI & ASSOCIATES, P.C., 8911 RESEARCH DRIVE, IRVINE, CA, 92618, US

(73) Assignee: CALIFORNIA BLUE, LLC, LOS ANGELES, CA (US)

(21) Appl. No.: 12/892,681

(22) Filed: Sep. 28, 2010

Related U.S. Application Data
(63) Continuation of application No. 11/571,655, filed on Jan. 4, 2007, now abandoned.
(60) Provisional application No. 60/619,591, filed on Oct. 15, 2004.

(51) Int. Cl. B05B 15/06

(52) U.S. Cl. 239/11; 239/532

(57) ABSTRACT

An apparatus for delivering liquid utilizing a wand with a nozzle, a toggle switch, and a supply canister for delivering self-tanning and sun-tanning solutions to a human body is disclosed. Projections on the wand facilitate a direct connection to a supply canister containing the chosen liquid to be delivered without the necessity of an exposed external tube suspended between the wand and the supply canister. The wand may be detached and reattached to the supply canister for storage or use.

### CROSS REFERENCE TO RELATED APPLICATIONS

This is a continuation of U.S. application Ser. No. 11/571,655 filed Jan. 4, 2007, which is a 371 application of PCT Application no. PCT/US2005/036976 filed Oct. 14, 2005, which claims the benefit of priority from U.S. Provisional Application No. 60/619,591, filed on Oct. 15, 2004.

### BACKGROUND OF THE INVENTION

The present invention generally relates to apparatus and methods for the delivery of liquid, and more specifically, to the delivery of spray tanning solutions by self-application.

With an increasing concern for health and safety, the advent of sunless tanning sprays has proven to be a significant advantage. However, the use of regular spray nozzles do not provide even application of the solution, nor do they facilitate the application of the solution on harder to reach places, particularly in cases of self-application.

In many other applications, pressurized spray devices provide more even application, but are cumbersome with the interference of long tubes used to convey the solution to the applicator or motors to provide pressurization. In many instances, the containers containing the tanning solution are separate from the applicator, therefore restricting the ability to move or ideally position the applicator, particularly during self-application. Likewise, the nozzles or applicators which provide a stream of tanning solution may be difficult to manage.

For example, one portable spray device as described in U.S. Patent Application No. US2004/0050962 A1 utilizes a cylindrical metal canister, similar to a propane tank, containing a propellant and a liquid. A long tube extends from the canister to a sprayer. The pressure allows nozzles in the sprayer to provide fluid in the form of a steady mist. The large size of the canister that encloses the propellant and liquid dictates that the device remain stationary on the ground. Therefore, only the nozzles may be easily manipulated.

U.S. Pat. No. 4,407,124 provides another example of a spray system wherein several reservoirs resembling aerosol canisters contain a liquid, and the reservoirs are held in pouches fixed on a belt of the user. A long coiled hose extends from a valve on the reservoir being used to a nozzle for spraying. Although the spray system is portable, the necessity of the pouch and belt may limit the user's maneuverability.

As further example of existing spray devices U.S. Patent Application No. US 2004/0251272 A1 presents a sunless tanning spray dispenser which includes a rigid outer canister having a valve and a nozzle. A tanning solution and a propellant are housed in the canister which resembles a common aerosol can. Unlike the previous examples, this spray device is unencumbered with long tubes or hoses or a stationary source of liquid. However, the user is limited to spraying only to the immediate vicinity of the canister. Therefore, should the user wish to achieve an even application to both the front and back of the body, the user may have difficulty in reaching certain areas of the back.

As can be seen, there is a need for an improved apparatus and method that can facilitate the application of a solution to various locations on the body while maintaining a steady stream of solution for an even application.

### SUMMARY OF THE INVENTION

In one aspect of the present invention, an apparatus for delivering liquid comprises a wand which attaches directly to a supply canister. The wand houses the entire length of a tube which conveys liquid from the supply canister to the nozzle.

In another aspect of the present invention, an apparatus for delivering liquid comprises a wand which contains the full length of a tube for conveying liquid, has a delivery end, a body, and a supply end that may be attached directly to a canister.

In a further aspect of the present invention, an apparatus for delivering liquid comprises a supply canister containing a liquid and a propellant, and a wand having an internal tube for receiving liquid directly from the supply canister.

In an additional aspect of the present invention, an apparatus for delivering liquid comprises a supply canister containing a propellant and a liquid, and a wand, comprising a body, including a tube, a tube opening, a toggle switch, an actuator, a valve and a nozzle, wherein the tube opening, toggle switch, actuator, valve and nozzle are linearly arranged along the tube. The wand further comprises a supply end having a plurality of projections for attaching the wand directly to the supply canister.

In yet another aspect of the present invention, an apparatus for delivering liquid comprises a supply canister containing a propellant and a liquid. Liquid from the supply canister travels through the canister tube into the wand which connects directly to the supply canister. The wand comprises a plurality of projections which secure the wand directly to the supply canister, a tube opening directly adjacent to a tube, an internal tube extending from a nozzle on one end of the wand to a tube opening on the opposite end of the wand, a toggle switch positioned near the center of the wand, an actuator adjacent to the toggle switch, and a valve adjacent to the actuator, wherein the liquid from the supply canister is conveyed through the canister tube into the tube toward the nozzle which sprays the liquid towards a chosen target.

In another aspect of the present invention, a method for the delivery of liquid is disclosed. The method comprises the steps of: maintaining liquid under pressure in a supply canister including a rim and a canister tube; holding a supply canister to the supply end of a wand having a delivery end including a nozzle, a supply end including a plurality of projections, and a body including a tube and a toggle switch within the body to the supply canister; flowing the liquid from the supply canister into a tube within the wand; controlling the flow of liquid using the toggle switch protruding from the median of the body; and delivering the liquid from the nozzle as a spray toward a chosen location.

These and other features, aspects and advantages of the present invention will become better understood with reference to the following drawings, description and claims.

### BRIEF DESCRIPTION OF THE DRAWINGS

FIG. 1 is a side view of a delivery device in accordance with an embodiment of the present invention;

FIG. 2 is a delivery end view of the delivery device of FIG. 1;

FIG. 3 is a side view of the delivery device of FIG. 1;

FIG. 4 is a top view of the delivery device of FIG. 1;

FIG. 5 is a perspective view of the delivery device of FIG. 1;

FIG. 6 is a cross sectional view of the delivery device of FIG. 1;

FIG. 7 is a supply end view of the delivery device of FIG. 1;

FIG. 8 is a perspective view of a toggle switch that may be employed in the delivery device of FIG. 1;

FIG. 9 is a perspective view of a nozzle that may be employed in the delivery device of FIG. 1;

FIG. 10 is a perspective view of a supply canister that may be employed in the delivery device of FIG. 1; and

FIG. 11 is a flow chart of a method for delivering liquid according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides apparatus and methods for delivering and applying liquids, such as to a human body. For example, the liquids delivered may be suntan lotion, sunscreen, sun-block, self-tanning solution, bronzing liquid, moisturizing lotions, special body sprays, and the like. In particular, the present invention may be used to facilitate self-application of the liquids, as the size and lightweight construction of the delivery device of the present invention enable a user to easily reach various locations on the body.

Unlike the prior art which utilizes a nozzle attached to a long intermediate tube joined to a canister, the present invention incorporates a nozzle and a pressurized supply canister into an integrated, portable spray device while maintaining a distance between the nozzle and supply canister so as to facilitate access to areas which may be difficult to reach. As such, in situations where the user would like to spray her back, the user may hold the wand in an inverted position over her shoulder, and direct it toward her back, thereby reaching areas she might not be able to access with a short nozzle.

The present invention has also eliminated the need for a lengthy exposed intermediate tube between the supply canister and the nozzle. The conventional air-brushing type of liquid delivery systems rely on a short spray gun or nozzle that is typically connected to a supply of compressed air via a lengthy exposed intermediate tube external to the spray gun. Often, the lengthy tube will hang suspended between the spray gun and the canister. An embodiment of the present invention uses a supply canister for holding liquid at a location remote from a nozzle location. A wand, which contains the entire length of a tube within, has a nozzle at one end and can be connected directly to the supply canister. Thus, the nozzle may be manipulated to spray the body at various angles and levels without the interference of external tubes.

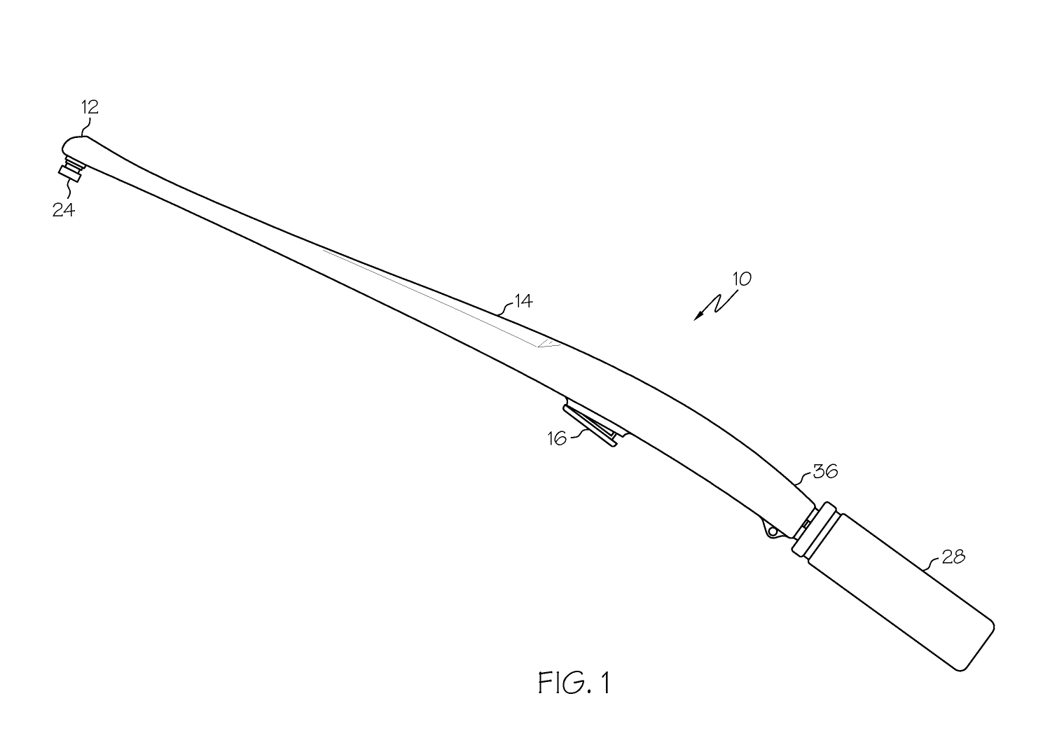

FIG. 1 is an illustration of a spray tanning delivery device 10 according to an embodiment of the present invention, which may comprise a wand 14 and a supply canister 28. The wand 14, which may be detached and reattached to the supply canister 28, may include a first or delivery end 12 and a second or supply end 36. The wand 14 may further include a nozzle 24 that may be located in the delivery end 12 so that liquid may exit the nozzle 24 as a spray. A toggle switch 16 may be positioned near the center of the wand 14. The user may use the toggle switch 16 to control the release of liquid towards the nozzle 24 by depressing or releasing the toggle switch 16. The supply canister 28 may attach to the wand 14 via a plurality of projections 38 located on the supply end 36 of the wand 14. The supply canister 28 may contain a propellant and the liquid to be delivered by the wand 14.

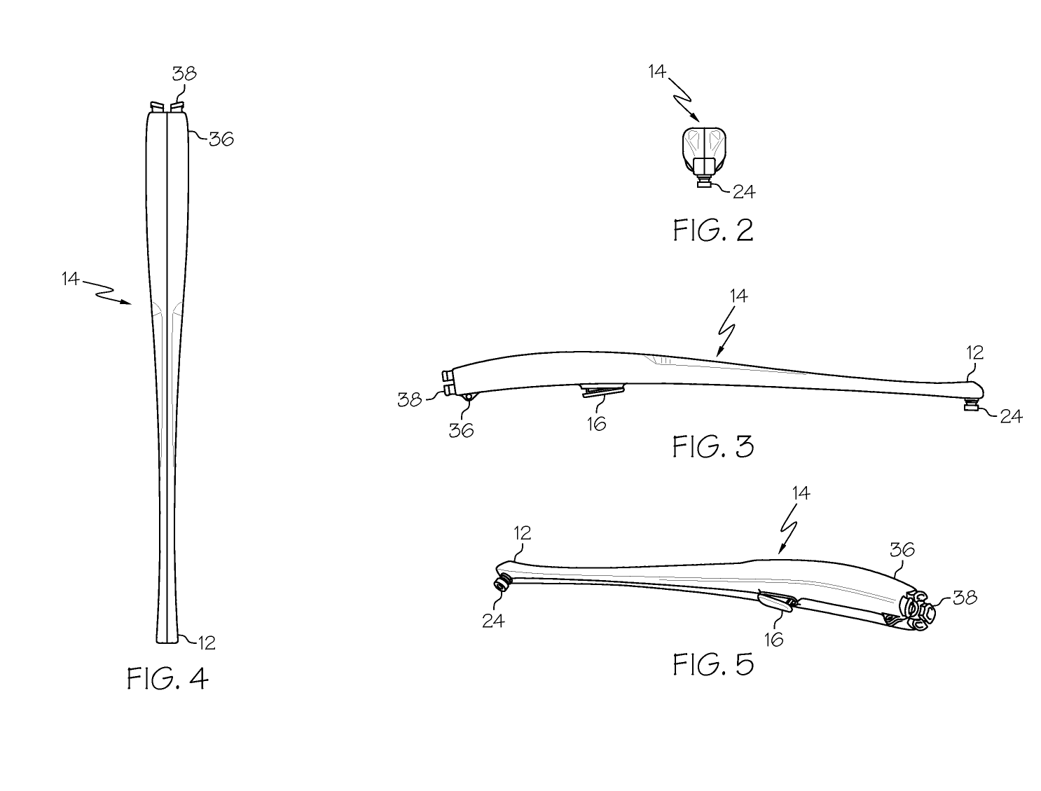

In the present embodiment, the wand 14, as illustrated by FIGS. 2 through 5, may comprise injection-molded plastic and may, for example, be approximately 14 inches (35.56 cm) to 18 inches (45.72 cm) in length. The projections 38 located on the supply end 36 may be integrally molded plastic as well. Alternatively, the wand 14 may be constructed from fiberglass. The length and light-weight construction of the wand 14 facilitates easy handling by the user, unlike the prior art where the user may be hampered with a nozzle located immediately atop a supply canister limiting the user's reach. In particular, the length of the wand 14 allows the user sufficient space to handle the wand 14 without interfering with the nozzle 24 which may be located on the delivery end 12, as the user may grip the wand 14 on the supply end 36 in order manipulate the toggle switch 16. In addition, the length of the wand 14 provides accessibility to locations on the body that may be difficult to reach, such as the length of the user's back. Furthermore, the wand 14, when constructed from plastic, may weigh approximately 2 ounces to 4 ounces, making it easy to lift and carry.

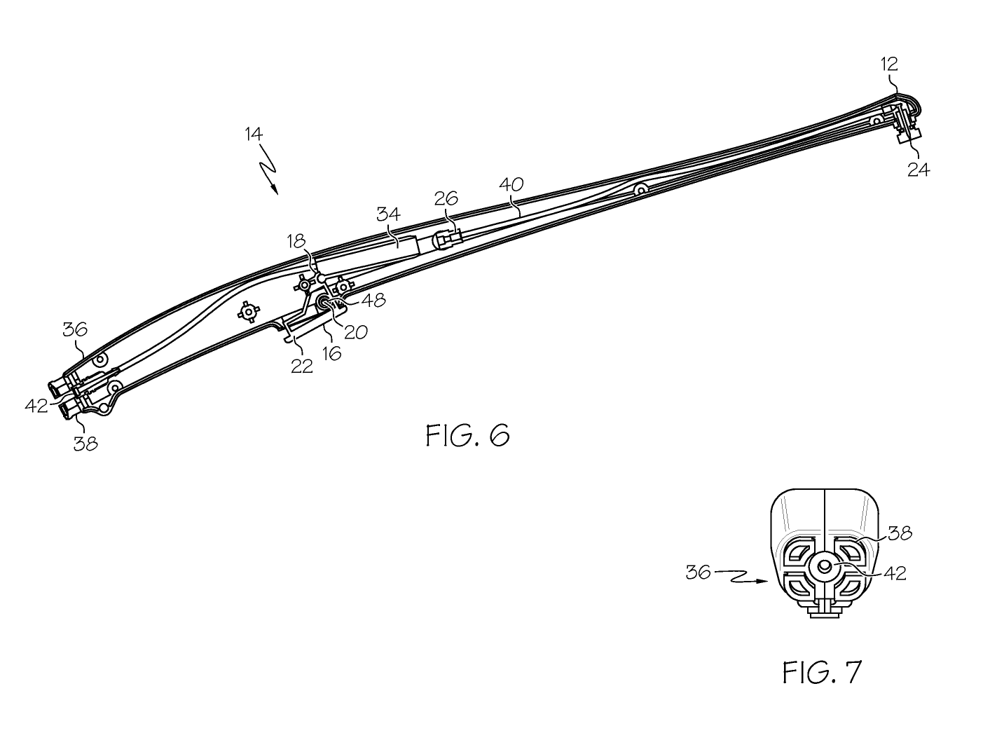

As seen in a cross-section view of the wand 14, shown in FIG. 6, the wand 14 may further comprise toggle switch 16, nozzle 24, valve 26, actuator 34, tube 40, and tube opening 42. The valve 26, actuator 34, and tube 40 may be located in the wand's 14 interior, as may the toggle switch 16, a portion of which may protrude from the wand 14 for manipulation by the user. The tube 40 may extend the length of the wand 14 from the tube opening 20 to the nozzle 24 (FIG. 6). The nozzle 24 may protrude from the delivery end 12 of the wand 14 to spray the liquid toward a chosen location.

As seen in FIG. 6, a tube 40 may be constructed from plastic, and may convey liquid obtained from the supply canister 28 from the tube opening 42 located between the projections 38 in the supply end 36 to the nozzle 24 located in the delivery end 12. The tube 40 may run the entire length of the wand 14. A valve 26 may be located between the tube opening 42 and the nozzle 24 and may work in conjunction with the hook end 18 of a toggle switch 16 and an actuator 34 to control the release of liquid from the tube 40 to the nozzle 24. Also located between the tube opening 42 and the nozzle 24 is a protrusion 48 on the wand 14 which is threaded through a hole 20 in the toggle switch 16.

The tube opening 42 may reside in the supply end 36 of the wand 14 (FIG. 7). The projections 38 (FIG. 7) which may also be located on the supply end 36 may facilitate a connection by the wand 14 to the supply canister 28 by attaching to the rim 32 of the supply canister 28. In the present embodiment, the projections 38 are configured to be thicker at the ends, causing the ends of the projections 38 to hold on to the rim 32 of the supply canister 28. As may be appreciated by those of ordinary skill in the art, several alternative means for securing the wand 14 to the supply canister 28 and providing a fluid connection for the contents of the supply canister 28 to the tube opening 42 of wand tube 40 may be employed.

For example, the supply canister 28 may have a protruding threaded valve (not shown) in place of the canister tube 44 (see FIG. 10). The wand 14 may then have a correspondingly threaded receptacle (also not shown) so that an aerosol, or other, type of supply canister 28 may be threaded into the wand 14 to be securely held to the wand 14.

Also, for example, a clamp could be attached as part of wand 14 to the supply end 36 of wand 14. When loose, the clamp may wrap around the end of supply canister 28, for example, wrapping around cap 30. The clamp may then be tightened to secure the supply canister 28 to the wand 14. The clamp attachment of wand 14 to supply canister 28 may function, for example, similarly to the design of a spring-form pan known in the art of baking.

FIG. 8 shows a perspective view of a toggle switch 16. The toggle switch 16 may comprise metal or plastic for example. The toggle switch 16 may selectively restrict liquid flow within the tube 40 inside the wand 14. The toggle switch 16 may have a lever 22 which protrudes from the center of the wand 14. A hole 20 on the toggle switch 16 may fit onto a protrusion 48 within the wand 14 allowing the toggle switch 16 to swivel around the protrusion 48. By depressing the lever 22, the toggle switch 16 may pivot thereby allowing the hook end 18 of the toggle switch 16 to engage the actuator 34. The actuator 34 may then make contact with the valve 26 (see FIG. 6).

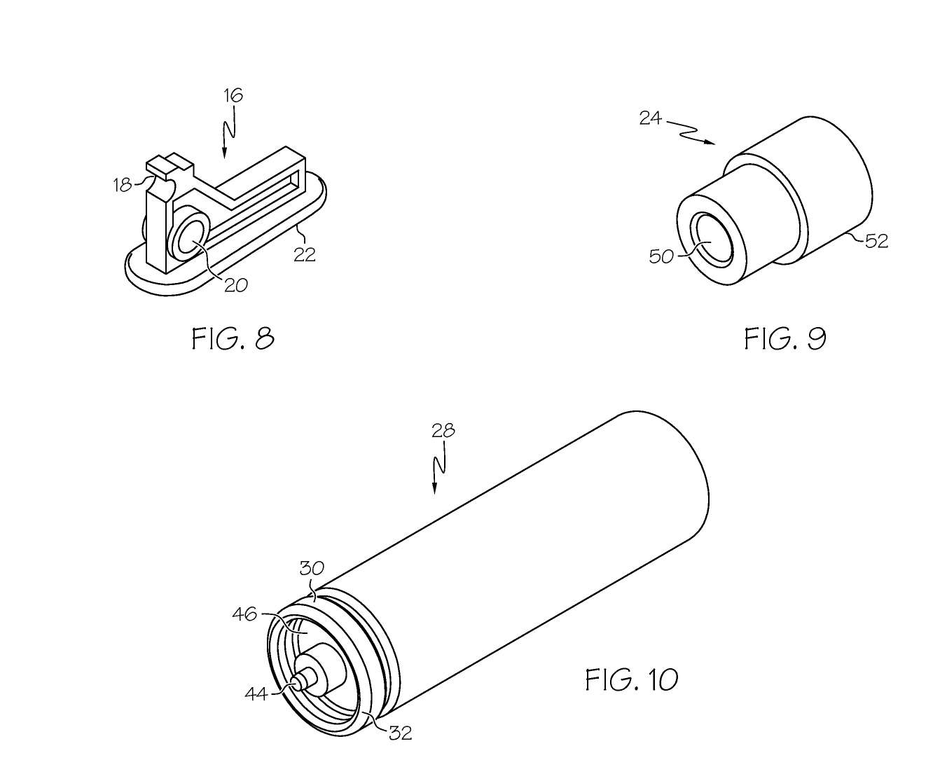

The valve 26, which may be directly adjacent to the actuator 34, may then be displaced by the contact with the actuator 34, thus allowing the release of liquid towards the nozzle 24 (FIG. 9). The liquid may travel through the tube 40 towards the nozzle 24, and upon reaching the nozzle 24, the liquid may then exit the wand 14 to be sprayed upon the desired location. As an alternative to using a toggle switch 16, a clamp may be used to control the flow of liquid to the nozzle. An external knob connected to the clamp may be manipulated by the user to open and close the clamp.

The nozzle 24, illustrated in FIG. 9, may comprise metal or plastic for example. A tube 40 may be inserted into the nozzle 24 through the nozzle entry 50. The nozzle head 52 may protrude from the delivery end 12 of the wand 14 to spray the liquid toward a chosen location. The user may direct the spray of liquid by aiming the nozzle head 52 toward the intended location.

FIG. 10 is an illustration of a supply canister 28. The supply canister 28 may contain a propellant and a liquid. The supply canister 28 may also have a standard sized cap 30. The cap 30 may further comprise an outer first surface 46 which may be pressure sensitive. Downward pressure applied to the outer first surface 46 of the cap 30 may cause the propellant to force the liquid through the canister tube 44. A canister tube 44 may protrude from the center of the outer first surface 46.

When the wand 14 is connected to the supply canister 28, the canister tube 44 may then be inserted into the tube opening 42 in the supply end 36 of the wand 14, which may allow liquid to flow from the supply canister 28, through the canister tube 44, into the tube opening 42, and through the wand tube 40. The wand 14 may be secured to the supply canister 28 by a plurality of projections 38 located on the supply end 36 of the wand 14. The projections 38 on the supply end 36 of the wand 14 may hold the rim 32 of the cap 30, as the projections may fit underneath the rim 32.

The projections 38 may apply downward pressure upon the outer first surface 46 of the cap 30 when the wand 14 is secured to the supply canister 28. When pressure is applied to the outer first surface 46 of the supply canister 28, the pressure may cause the propellant contained in the supply canister 28 to force the liquid through the canister tube 44. The liquid then travels from the canister tube 40 through the tube opening 42 on the supply end 36 of the wand 14 and into the tube 40.

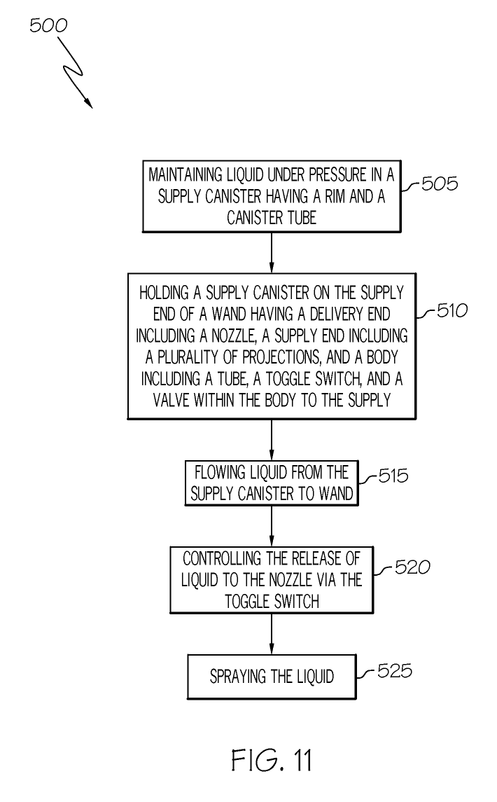

FIG. 11 represents a flow chart for a method 500 of delivering liquid beginning with step 505. In step 505, a liquid and a propellant may be maintained in a supply canister 28, such as the supply canister 28 represented in FIG. 10. The supply canister 28 may have a cap 30 sensitive to external pressure. The application of downward pressure upon the cap 30 may cause the propellant within the supply canister 28 to force the liquid from the supply canister 28.

In the following step 510, a wand having a plurality of projections 38, such as the wand 14 exemplified by FIGS. 2 through 6, holds the supply end 36 of the wand 14 to the canister 28 via the projections 38 on the wand 14. Thereafter, in step 515, liquid from the supply canister 28 may be flowed into the wand 14 when the pressure from the wand 14 onto the canister cap 30 causes the propellant to force the liquid through the canister tube 44.

Next, in step 520, the flow of liquid may be controlled by the toggle switch 16 which signals the valve 26 to release liquid toward the nozzle 24. The toggle switch 16 may be of the same form and structure as that represented in FIG. 8. The depression of the toggle switch 16 may cause the delivery of liquid to the nozzle 24, whereas the release of the toggle switch 16 may prevent the liquid from flowing to the nozzle 24. In the last step 525, the liquid may be sprayed from the nozzle 24 of the wand 14.

It should be understood, of course, that the foregoing relates to exemplary embodiments of the invention and that modifications may be made without departing from the spirit and scope of the invention as set forth in the following claims.

We claim:

1. An apparatus for delivering liquid, comprising:
a wand having an entire length of tube therewithin, wherein the wand houses an entire length of the tube;
a supply canister attached directly to said wand on a first end of the wand, the supply canister supplying the liquid to a first segment of the tube;
a nozzle connected to a second end of the wand;
a pivotable toggle switch protruding from the wand wherein the toggle switch includes a hook end;
a valve located within the wand; and
an actuator, adjacent to the valve, connected to the first segment of the tube wherein depressing of the toggle switch causes the hook end to engage the actuator and cause the valve to release fluid to pass through the a second segment of tube to the nozzle head.

2. The apparatus of claim 1, wherein the tube extends from a tube opening to the nozzle.

3. The apparatus of claim 1, wherein the wand further comprises:
a tube opening attached to the tube to receive liquid from the supply canister.

4. The apparatus of claim 3, wherein the tube opening is located on the first end of the wand opposite from the nozzle.

5. The apparatus of claim 1, wherein the wand further comprises:
a plurality of projections extending from the first end of the wand and which plurality of projections attach the wand to the supply canister.

6. An apparatus for delivering a spray tanning solution, comprising:
a supply canister containing the spray tanning solution and a propellant;
a wand which contains an entire length of a tube for conveying the spray tanning solution, said wand having a delivery end, a body, and a supply end including a plurality of projections that may be attached directly to the supply canister,
wherein the tube extends a length of the body and the body further comprises:
a toggle switch medially located on the body to control a release of liquid to the delivery end, and
an actuator to control the release of liquid from the tube,
wherein the actuator and the tube are located in an interior of the wand.

7. The apparatus of claim 6, wherein the wand is between 14 to 18 inches long.

8. The apparatus of claim 6, wherein the delivery end includes a nozzle for spraying the liquid.

9. The apparatus of claim 6, wherein the delivery end is angled to give a user accessibility to areas otherwise difficult to reach.

10. The apparatus of claim 9, wherein the delivery end is angled between 1 to 15 degrees.

11. An apparatus for delivering a spray tanning solution, comprising:
a supply canister containing the spray tanning solution and a propellant;
a cap on the supply canister wherein the cap includes a rim;
a wand having a completely internal tube for receiving spray tanning solution directly from said supply canister which attaches directly to said wand,
wherein the wand further comprises:
a nozzle,
an actuator;
a tube opening, and
a toggle switch,
wherein the tube delivers fluid from the tube opening to the nozzle, the toggle switch controls a release of spray tanning solution to the nozzle when the actuator is engaged by the toggle switch, and the nozzle sprays the spray tanning solution towards a chosen location, and
a plurality of projections protruding from an end of the wand wherein the plurality of projections may engage the cap and each projection may fit under the rim.

12. The apparatus of claim 11 wherein the tube extends an entire length of the wand.

13. The apparatus of claim 12, wherein the tube extends from the tube opening to the nozzle to convey liquid from the tube opening to the nozzle.

14. The apparatus of claim 11, wherein the toggle switch between the tube opening and the nozzle.

15. An apparatus for delivering liquid, comprising:
a supply canister containing a propellant and a liquid; and
a wand, having:
a body, including a tube therewithin, having a first end which is attached to a tube opening for receiving liquid,
a toggle switch which engages an actuator
a valve controlled by the actuator, the valve controlling a flow of liquid, and
a nozzle attached to a second end of the tube for spraying the liquid,
wherein the tube opening, toggle switch, actuator, valve, and nozzle are linearly arranged, in the order listed, along the tube, which is completely contained within said wand; and
a supply end that includes a plurality of projections for attaching the wand directly to the supply canister.

16. The apparatus of claim 15, wherein the tube extends a length of the wand.

17. The apparatus of claim 15, wherein the tube extends from the tube opening to the nozzle to supply liquid to the nozzle.

18. The apparatus of claim 15, wherein the toggle switch and actuator, are positioned between the tube opening and the nozzle to control the flow of liquid to the nozzle.

19. The apparatus of claim 15, wherein the toggle switch is adjacent to the actuator.

20. An apparatus for delivering spray tanning solution, comprising:
a wand which connects directly to a supply canister, including:
one of a plurality of projections, a threaded receptacle, and a clamp which secure the wand directly to the supply canister,
a tube opening directly adjacent to a first tube segment for receiving pressurized spray tanning solution from the supply canister,
a pivotable toggle switch positioned near the center of the wand which engages an actuator adjacent to the toggle switch for controlling a valve which allows a flow of spray tanning solution within a second tube segment fluidly connecting the valve with the nozzle, and restricting a release of spray tanning solution to the nozzle,
said supply canister containing a propellant and the spray tanning solution, said supply canister for providing the wand with spray tanning solution through a canister tube, and
wherein the spray tanning solution from the supply canister is conveyed through the canister tube into the internal tube and towards the nozzle which sprays the spray tanning solution towards a chosen location.

21. A method for delivering liquid which comprises the steps of:
maintaining liquid under pressure in a supply canister having a rim and a canister tube;
holding a supply canister directly on a supply end of a wand having:
a delivery end including a nozzle,
a supply end, and
a body including a wand tube, housed by the body, and a toggle switch;
flowing the liquid from the canister into the wand tube within the wand;
controlling the release of liquid to the nozzle via the toggle switch protruding from the median of the body; and
spraying the liquid from the nozzle.

22. The method as defined in claim 21, wherein the holding step is accomplished by a plurality of projections on the wand gripping the rim of the supply canister.

23. The method as defined in claim 21, wherein the flowing step is accomplished by the pressure in the supply canister forcing the liquid to travel through the canister tube into the wand tube when the wand is holding onto the supply canister.
